(19) United States
(12) Patent Application Publication
(10) Pub. No.: US 2009/0063047 A1
(43) Pub. Date: Mar. 5, 2009

(54) Navigational information display system, navigational information display method, and computer-readable recording medium

(75) Inventor: Shinichi Ono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/215,404

(22) Filed: Jun. 27, 2008

Related U.S. Application Data
(63) Continuation of application No. PCT/JP2005/024126, filed on Dec. 28, 2005.

(51) Int. Cl. G01C 21/36

(52) U.S. Cl. 701/211

(57) ABSTRACT

A navigational information display system includes latitude-and-longitude information and image receiving unit which receives latitude and longitude information of active type electronic tags installed in real space, and receives an image of a real scene containing objects. This system further includes an image-and-object matching processing unit which separates an image of an object containing an object image of the surroundings of each electronic tag from the image of the real scene, and calculates a relative distance of each electronic tag and a position of the object on the image of the real scene; and an image-and-route matching processing unit which estimates a display position of a route to a destination set in advance on the image of the real scene to calculate a size of navigational symbol information on the basis of the latitude and longitude information of each electronic tag, information on the route to the destination, and the calculated position of the object. In this system, navigational information containing the navigational symbol information is superimposed on the image of the real scene and then displayed.

### CROSS REFERENCE TO RELATED APPLICATION

This is a Continuation of Application No. PCT/JP05/024126 filed on Dec. 28, 2005. The entire disclosure of the prior application is hereby incorporated by reference herein in its entirety.

### BACKGROUND OF THE INVENTION

1. Field of the Invention

The present invention relates to a navigational information display system for virtually displaying, in real space, navigational information including navigational symbol information for showing a route (path) to a destination and marker information showing the location of a destination, a navigational information display method therefor, and a computer-readable recording medium having stored thereon a program for carrying out the navigational information display method.

2. Description of the Related Art

Generally, when a user travels to a unknown town, area or the like, and looks for a intended location (i.e., destination), a user walks while comparing real space (i.e., actual scene) with a map designed on a paper sheet, hereinafter referred to as “paper map”, or an electronic map containing latitude and longitude information on any places obtained from GPS, etc., and also, carries out navigation by looking for the intended location. GPS is an abbreviation for Global Positioning System, i.e., a system which receives radio waves sent out by artificial satellites to measure latitude, longitude and altitude of a current position. However, in locations where a radio wave transmitted from an artificial satellite cannot reach, such as a space between buildings, the inside of a room, and underground, GPS as described above cannot work well. Therefore, the latitude and longitude information of a predetermined position cannot be obtained.

To cope with such a disadvantage, navigation, i.e., navigation utilizing a VR (Virtual Reality) technique has been carried out conventionally by tracing a route to a destination by a user, a marker (e.g., an arrow) associated with the destination and the like on a two-dimensional electronic map thereby to previously define navigational information including information on the route, and information on the marker, and by superimposing and displaying the navigational information on the electronic map thus defined in advance on an image (or a picture) of real space captured by a portable information terminal, such as a PDA (Personal Digital Assistant) equipped with a camera or a camera phone. Alternatively, a user may perform ambient navigation while seeing his own virtual image which is obtained by ambient projection of information on a route to a destination or marker information associated with the destination onto a three-dimensional perspective view showing real space, using virtual eyeglasses, etc., provided on a portable information terminal.

More specifically, in connection with the technology for a conventional navigational information display system, Patent Document 1 (Japanese Unexamined Patent Publication (Kokai) No. 2004-48674) discloses a visual field coincidence type information presentation system in which a marker contained in real space is recognized by a camera-equipped PDA or the like, and navigational information (e.g., an arrow) specified by the marker is superimposed and displayed on an image of the real scene.

Further, as shown in Patent Document 2 (Japanese Unexamined Patent Publication (Kokai) No. 2000-205888), a method of acquiring position and bearing information is disclosed, by which a passive-type electronic RFID tag (Radio Frequency Identification) is used instead of GPS to plot a position of a user on a two-dimensional electronic map displayed by a display unit of a notebook-size personal computer or the like. It should be noted that an electronic tag is also known as an “IC tag”.

However, in Patent Document 1, a user must find a marker in real space on his own and after that, the marker needs to be captured within a shooting range and the angle of view of a camera. In addition, only the navigational information coming from a marker which is present in an image captured by the camera and which can be recognized by the camera can be obtained.

On the other hand, according to Patent Document 2, a passive type electronic tag (passive type IC tag) with no power supply provided therein is used. Therefore, only information of the electronic tag when a user comes to a position where the user is almost in contact with the electronic tag can be obtained, and information of another electronic tag close to but spaced at certain distance from the user cannot be obtained. On that account, there is the problem that only navigational information based on the origin defined by the electronic tag to which the user is close can be obtained.

Further, in Patent Document 2, it is troublesomely necessary to install navigational information in a passive type electronic tag or to input the navigational information in a link destination specified by a passive type electronic tag.

Conventional navigational information display systems and their problems are described later in detail with reference to the drawings.

### SUMMARY OF THE INVENTION

It is an object of the present invention to provide a navigational information display system, a navigational information display method, and a computer-readable recording medium, which can carry out navigation efficiently even in a location in which GPS cannot be used, such as a space between buildings, the inside of a room or underground, by precisely superimposing navigational information on an image of a real scene and continuously displaying the information in real space.

To achieve the above-described object, a navigational information display system according to one aspect of the present invention includes a latitude-and-longitude information and image receiving unit for receiving latitude and longitude information of electronic tags (i.e., active type electronic tags) which self-emit a short-range radio signal and are installed in real space, and receiving an image of a real scene containing objects captured by an information terminal device; an image-and-object matching processing unit for extracting an object image of the surroundings of each electronic tag, separating an image of an object containing an object image of interest from the image of the real scene, calculating a relative distance of each electronic tag with respect to the information terminal device, and calculating a position of the object on the separated object image; and an image-and-route matching processing unit for estimating a display position of a route to a destination set in advance on the image of the real scene to calculate a size of navigational symbol information at the indication on the basis of the received latitude and longitude information of each electronic tag, information on the route to the destination, and the calculated position of the object. In the navigational information display system, navigational information containing the navigational symbol information is superimposed on the image of the real scene and displayed in real space.

It is preferable that in the navigational information display system, not only the navigational symbol information, but also the time required to get to the destination and information on architectural structures in the surroundings of the destination are displayed in real space as the navigational information.

Further, it is preferable that in the navigational information display system, not only the navigational symbol information, but also marker information showing the location of the destination is displayed in real space as the navigational information.

A navigational information display system according to another aspect of the present invention includes a latitude-and-longitude information and image receiving unit for receiving latitude and longitude information of at least three electronic tags (i.e., active type electronic tags) which self-emit short-range radio signal and are installed in a real space, and receiving an image of a real scene containing objects captured by an information terminal device; an image-and-object matching processing unit for extracting an object image of the surroundings of each electronic tag, separating images of at least three objects containing an object image of interest from the image of the real scene, calculating a relative distance of each electronic tag with respect to the information terminal device, and calculating positions of the at least three objects on the separated object images; and an image-and-route matching processing unit for estimating a display position of a route to a destination set in advance on the image of the real scene to calculate a size of navigational symbol information at the indication on the basis of the received latitude and longitude information of each electronic tag, information on the route to the destination, and the calculated object positions. In the navigational informational display system, navigational information containing the navigational symbol information is superimposed on the image of the real scene and displayed in real space.

Further, a navigational information display method according to another aspect of the present invention includes receiving latitude and longitude information of electronic tags which self-emit a short-range radio signal and are installed in real space, and an image of a real scene containing objects; extracting an object image of the surroundings of each electronic tag, followed by separating an image of an object containing an object image of interest from the image of the real scene, calculating a relative distance of each electronic tag, and calculating a position of the object on the separated object image; estimating a display position of a route to a destination set in advance on the image of the real scene to calculate a size of navigational symbol information at the indication, on the basis of the received latitude and longitude information of each electronic tag, information on the route to the destination, and the calculated position of the object; and superimposing navigational information containing the navigational symbol information on the image of the real scene to display the image of the real scene with the navigational information superimposed thereon in real space.

In summary, according to a navigational information display system and a navigational information display method according to the present invention, latitude and longitude information acquired from active type electronic tags installed in real space, and an object image containing an image of the surroundings of each active type electronic tag are used to estimate the position of previously set navigational information (e.g., information on a route to a destination) in real space. Thus, the navigational information can be superimposed on an image of a real scene captured by a camera or the like, and the resultant image with navigational information superimposed thereon can be continuously displayed in real space. As a result, it is possible to carry out navigation efficiently even in a location in which GPS cannot be used, such as a space between buildings, the inside of a room or underground.

Further, according to a navigational information display system and a navigational information display method according to the present invention, an information terminal device held by a user obtains navigational information without installing navigational information in an electronic tag or putting navigational information in a link destination specified by an electronic tag. Therefore, customized navigational information can be sent to a user. In addition, it is possible for a plurality of navigational information providers to utilize a navigational information display system.

### BRIEF DESCRIPTION OF THE DRAWINGS

The present invention will be described below with reference to the accompanying drawings, wherein:

FIG. 1 is a conceptual illustration of a conventional navigational information display system conceptually showing the system;

FIG. 2 is a conceptual illustration of a conventional navigational information display system conceptually showing the system;

FIG. 3 is a block diagram showing a schematic configuration of the conventional navigational information display system;

FIG. 4 is a block diagram showing a configuration of a navigational information display system according to an embodiment;

FIG. 5 is a flowchart explaining a process flow to display navigational information according to the present invention;

FIG. 6 is a flowchart explaining details of process flows by the image-and-object matching processing unit and the image-and-route matching processing unit as shown in FIG. 5.

FIG. 7 is a representation of a displayed image showing a condition that navigational information superimposed on an image of a real scene, which is used according to the present invention, is displayed.

FIG. 8 is a diagrammatic illustration showing the way of using the absolute coordinate of a moving user to estimate the display position of a navigation object;

FIG. 9 is a diagrammatic illustration showing the way of using fixed tags buried in real space to estimate the display position of a navigation object;

FIG. 10 is a diagrammatic illustration showing the way of using passive type electronic tags to display navigational information; and

FIG. 11 is a diagrammatic illustration showing the way of using active type electronic tags to display navigational information.

### DESCRIPTION OF THE PREFERRED EMBODIMENTS

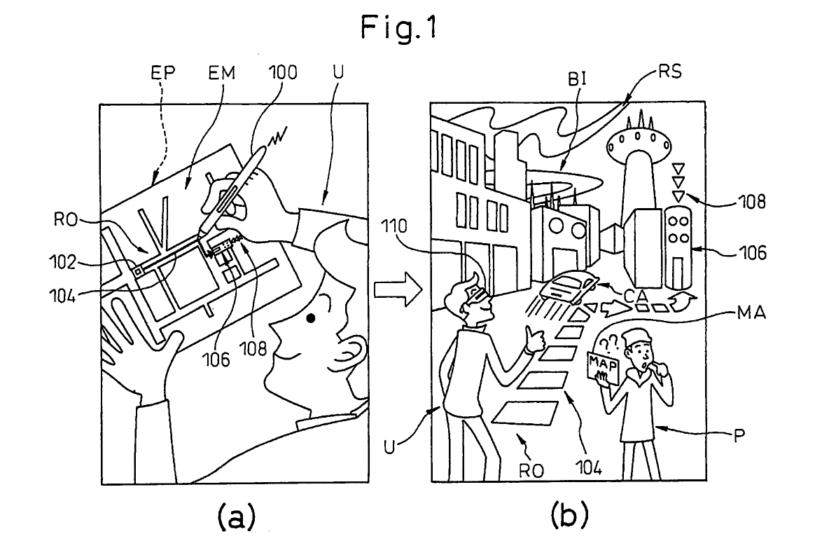

Before describing the structure and process flow of a navigational information display system according to an embodiment, a typical example of conventional navigational information display systems, and the associated problems will be described in detail with reference to the accompanying drawings (FIGS. 1 to 3).

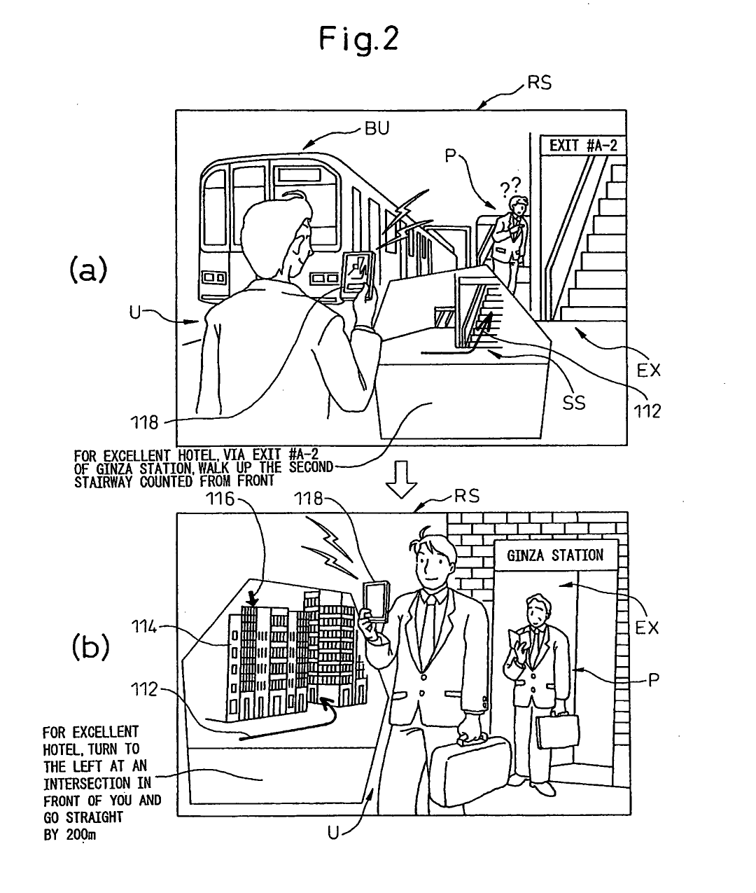

FIGS. 1 and 2 are each a conceptual illustration of a conventional navigational information display system conceptually showing the system. A basic concept of a conventional navigational information display system will be described by comparing the following two situations. In the first situation, a user carries out navigation while walking and comparing real space with a paper map or an electronic map containing latitude and longitude information of positions obtained by GPS. In the second situation, a user carries out ambient navigation while seeing his own virtual image shown in an image of a real scene. The same constituents as those described above are hereinafter designated by same reference numerals.

When a user U (or another user P) travels to an unknown town and looks for the location of a destination 106, the user uses an electronic pen 100 to trace a route (path) 104 from a start point 102 to the destination 106 and marker information (e.g., an arrow) associated with the destination 10a6 on a two-dimensional electronic map EM containing information on the latitude and longitude of a vicinity of the destination 106 and information on a road RO as shown in a portion (a) of FIG. 1, whereby navigational information containing information on a route to the destination and a marker associated with the destination is defined previously. In this case, electronic paper EP, such as an Anoto paper (“Anoto” is a registered trademark of Anoto Group AB of Sweden) used to detect cutoff of light by the trail of the electronic pen 100, or ultrasonic paper used to detect cutoff of ultrasonic waves by the trail of the electronic pen 100 may be used instead of the electronic map EM. Alternatively, a map M simply drawn on a paper sheet may be used.

Otherwise, a person other than the user U at a remote location may trace navigational information containing a route from a previously set position to a destination and marker information associated with the destination on the electronic map for the other person concerned, thereby transmitting the navigational information to a portable information terminal of the user U through a network in real time.

The user U previously stores the navigational information in a set of virtual eyeglasses (or an ambient projection device) 110 provided on the portable information terminal of the user U as shown in a portion (b) of FIG. 1. When the user U wears the set of virtual eyeglasses 110 having the navigational information stored therein after getting to a strange town, the user will see, over the set of virtual eyeglasses 110, an real space containing architectural structures BI, such as a road RO or a construction (e.g., a building), a moving car CA and others (three-dimensional scene) RS. In other words, the user U carries out ambient navigation while seeing his own convenient virtual image formed in an image of a real scene RS resulting from ambient projection of the navigational information as described above, and thus the user can readily find out the destination 106 within a short space of time. However, the method of ambient navigation involves a troublesomeness that a user must wear a set of virtual eyeglasses on every occasion and an inconvenience that information of a route to a destination pre-stored in the set of virtual eyeglasses is fixed information.

Further, it is difficult for the other user P to find out the destination 106 for a short time. This is because he carries out navigation while walking and comparing a real space RS with a paper map M or an electronic map EP, in which the navigational information as described above has been entered.

On the other hand, when the user U attempts to look for a hotel of the destination 114 (e.g., “The Excellent Hotel”) on a subway station, where radio waves transmitted from an artificial satellite cannot be received, i.e., a place in which GPS does not work well, navigational information containing a route to the hotel and a marker associated with the hotel is defined in advance by tracing the route 112 to the destination 114 and the marker information 116 associated with the destination on a two-dimensional electronic map containing information concerning vicinities of the hotel as in the case described with reference to the portion (a) of FIG. 1. The navigational information thus defined is previously stored in a portable information terminal 118 of the user U, such as a camera-equipped PDA or a camera phone. In parallel with this, guide information by voice to guide the user U to the hotel is also stored in the portable information terminal 118 in advance.

Next, as shown in a portion (a) of FIG. 2, while comparing a real space RS containing a bus stop BU and an exit EX with a three-dimensional image displayed on a display unit of the portable information terminal 118 corresponding to the real space RS in a subway station which radio waves transmitted from an artificial satellite cannot reach, the user U would walk up the second stairway SS counted from the front, which is the closest to the hotel, to come out of the subway station according to vocal guide information (e.g., for “The Excellent Hotel”, via Exit #A-2, Ginza station, first go to the second stairway counted from the front).

Further, at the time when the user U goes out the exit EX, the user U can arrive at the hotel according to guide information by voice (e.g., for “The Excellent Hotel”, turn to the left at an intersection in front of you and go straight by 200 m″) while seeing a virtual image produced by superimposing a real space RS including architectural structures BI on a three-dimensional image displayed on the display unit of the portable information terminal 118 corresponding to the real space RS, as shown in a portion (b) of FIG. 2. However, the method of navigation utilizing such guide information by voice can make it more difficult to discover the hotel at the destination 114 within a short time when the vocal guide information does not correspond to the real space well.

Incidentally, it is more difficult for the other user P to reach the destination 114 as in the case described with reference to the portion (b) of FIG. 1 because he carries out navigation while walking and comparing the real space RS with a paper map or electronic map, in which the navigational information as described above has been entered.

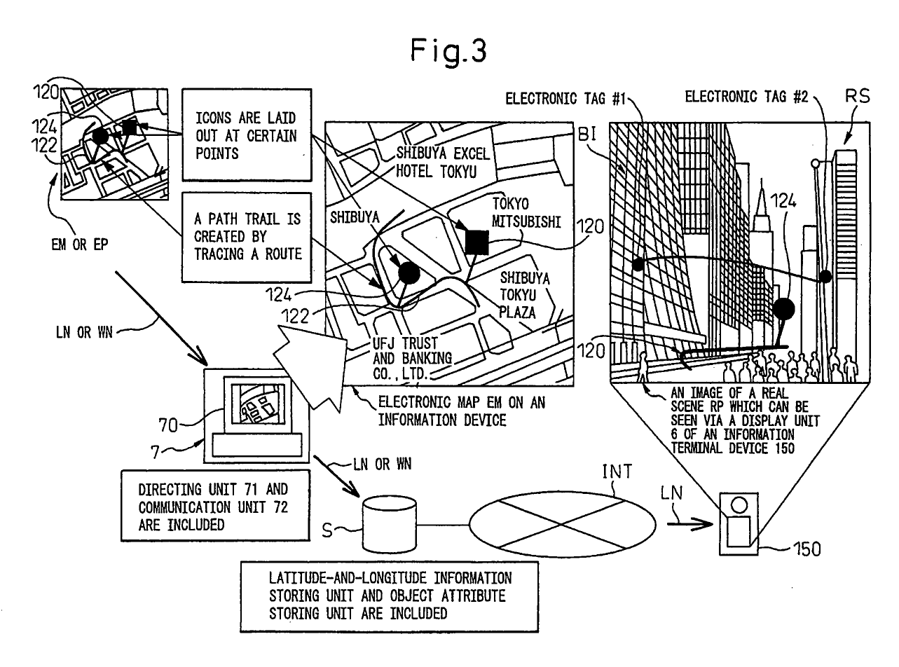

FIG. 3 is a block diagram showing a schematic configuration of a conventional navigational information display system. However, the conventional navigational information display system is simplified, and only the configuration of its important portions is shown in the drawing.

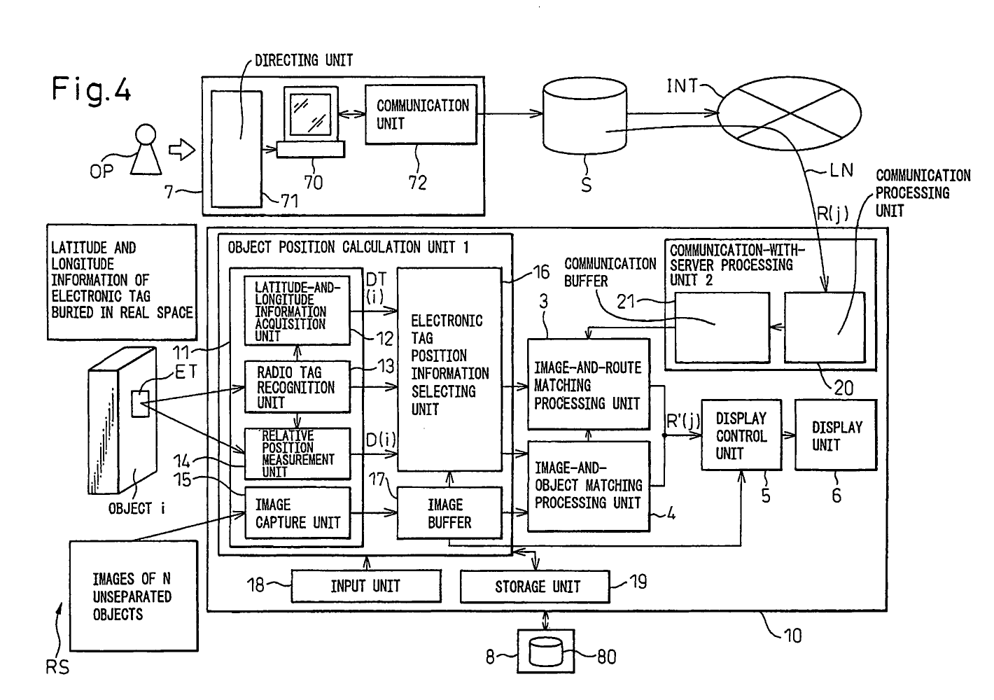

The conventional navigational information display system as shown in FIG. 3 is provided with an information device 7. The information device has a directing unit 71 including an input means such as a mouse (see the later description presented with reference to FIG. 4); a personal computer 70 for appropriately processing various kinds of information entered through the directing unit 71; and a communication unit 72 including a controller for transmitting various kinds of information processed by the personal computer 70 to a server device S (see the later description presented with reference to FIG. 4). Herein, on the display unit of the personal computer 70 is displayed an electronic map EM or electronic paper EP created by a map application software program.

When a user travels to an unknown town and looks for a destination 124, the user per or another person in a remote location first lays out icons showing the start point 120 and destination 124 on a two-dimensional electronic map EM or electronic paper EP, in which information on the latitude and longitude of a vicinity of the destination 124 has been entered. Further, the user or another person in the remote location uses an electronic pen to trace a route (path) 122 from the start point 120 to the destination 124 and create a path trail from the start point 120 to the destination 124, and then sends out it to the personal computer 70 through a wireless network or wired network WN, thereby previously defining navigational information such as information on a route to the destination and marker information associated with the destination. As a result of defining such navigational information in advance, drag and drop of icons or characters or a combination of them, which show the start point 120 and destination 124, can be correctly performed and objects of the route 122 and other things represented by line drawings, are laid out on the electronic map EM or electronic paper EP.

The latitude and longitude information associated with the object concerned is obtained from the objects laid out on the electronic map EM or electronic paper EP (an icon is a piece of information representing a point, and a path trail is a piece of information represented by discrete points on a route). The latitude and longitude information and object attribute information (including e.g., shapes and lengths of time to arrive there) are temporarily stored in a storage unit (not shown) of the information device 7.

The latitude and longitude information and object attribute information thus obtained and stored are transmitted to the server device S through the wireless network LN or wired network WN by the communication unit 72 of the information device 7, and stored in a latitude-and-longitude information storing unit and an object attribute storing unit in the server device.

Further, the navigational information display system as shown in FIG. 3 is provided with an information terminal device 150 composed of a portable information terminal, such as a camera-equipped PDA or a camera phone.

The latitude and longitude information and object attribute information stored in the latitude-and-longitude information storing unit and object attribute storing unit in the server device are sent out to the information terminal device 150 through the Internet INT and wireless network LN.

In the case in which a user travels to an unknown town and carries out navigation to look for the location of a destination 124, when the user can carry out navigation while seeing a virtual image produced by superimposing an real space RS including architectural structures BI and others captured with the camera of the information terminal device 150 on an image of a real scene RP corresponding the real space, which can be seen through the display unit 6 of the information terminal device 150 (see the later description presented with reference to FIG. 4), he can readily reach the destination 124 within a short space 6 time.

However, with the navigational information display system as shown in FIG. 3, GPS cannot work well in a place which radio waves transmitted from an artificial satellite cannot reach, such as a space between buildings, the inside of a room or an underground, and therefore it is impossible for a user to obtain latitude and longitude information of a position in which the user is at present in the middle of navigation.

To cope with such a disadvantage, using a passive type electronic tag of RFID (e.g., electronic tags #1 and #2 displayed on the image of the real scene RP of FIG. 3) instead of GPS to plot the position in which the user is at present on the image of the real scene RP, as described in the above-mentioned Patent Document 2, may be conceived.

However, in the case of using passive type electronic tags as described above, only the information on the electronic tag which a user is approaching can be obtained, and the information on another electronic tag even at a short distance from the user cannot be obtained. Therefore, there has been the problem that only the navigational information based on the electronic tag to which a user comes close and which defines the navigating origin can be obtained.

The configuration and process flow of a navigational information display system according to an embodiment will be described below in detail with reference to the accompanying drawings (FIGS. 4 to 11).

FIG. 4 is a block diagram showing the configuration of a navigational information display system according to an embodiment, in which the configuration of the navigational information display system is simplified.

As in the case of the conventional navigational information display system as shown in FIG. 3, the navigational information display system according to the embodiment shown in FIG. 4 is provided with an information device 7 having a directing unit 71 including an input means such as a mouse, a personal computer 70, and a communication unit 72 such as a controller. On a display unit of the personal computer 70 is displayed an electronic map or electronic paper (not shown in FIG. 4).

When a user enters an unknown town and looks for the location of a destination, the user per se or an operator OP in a remote location uses an electronic pen to trace a route from a start point to the destination on a two-dimensional electronic map or electronic paper, in which latitude and longitude information of a vicinity of the destination has been entered, and create a path trail from the start point to the destination, and then sends out it to the personal computer 70 through a network, thereby previously defining navigational information, such as information on a route to the destination and marker information associated with the destination, as in the case of the conventional navigational information display system as shown in FIG. 3. As a result of defining such navigational information in advance, drag and drop of icons or characters or a combination of them, which show the start point and destination, and objects of the route and other things represented by line drawings, are laid out on the electronic map or electronic paper.

The latitude and longitude information associated with the objects previously defined on the electronic map or electronic paper is obtained, and then the latitude and longitude information and object attribute information are temporarily stored in a storage unit (not shown) of the information device 7.

The latitude and longitude information and object attribute information thus acquired and stored are transmitted to the server device S through a network by the communication unit 72 of the information device 7, and stored in a latitude-and-longitude information storing unit (not shown) and an object attribute storing unit (not shown) in the server device.

Further, the navigational information display system as shown in FIG. 4 is provided with an information terminal device 10 composed of a portable information terminal such as a camera-equipped PDA or a camera phone.

The latitude and longitude information and object attribute information stored in the latitude-and-longitude information storing unit and object attribute storing unit in the server device are sent out to the information terminal device 10 through the Internet INT and wireless network LN. The latitude and longitude information and object attribute information contains navigational information, such as information on a route to a destination and information on a marker associated with the destination, which has been defined in advance.

As shown in FIG. 4, in the real space, active type electronic tags ET are each buried in a location of a road sign, a shop, a store or the like in a town usually, provided that the latitude and longitude information of the locations has been stored in the electronic tags previously. The “active type electronic tag” is hereinafter abbreviated to “electronic tag” unless otherwise stated. However, only one electronic tag ET is shown as a representative here for the sake of simplicity of the description.

The electronic tag ET has a built-in power supply, and is arranged so that it emits short-range radio signals according to the standard of UWB (UWB: Ultra Wideband—a radio technique of sending and receiving data utilizing radio waves of a wide band of several Giga-Hertz) or the standard of Bluetooth (Registered Trademark)(a wireless communication standard for connecting a computer, peripheral device and the like by wireless) in itself thereby to send latitude and longitude information of a relevant position and object information including an image of a surrounding area of the position. The latitude and longitude information and object information including an image of a surrounding area sent out from the electronic tag ET is received by and read in the information terminal device 10.

In the embodiment shown in FIG. 4, the information terminal device 10 has the function of acquiring latitude and longitude information and objects containing images of areas surrounding the electronic tags from electronic tags ET buried in the real space to calculate a relative distance of each electronic tag with respect to the information terminal device 10, and a position of an object i corresponding to each electronic tag. The information terminal device 10 has the function of estimating a display position of a route to the destination on an image of a real scene captured by a camera of the information terminal device 10, on the basis of the latitude and longitude information of each electronic tag ET and the information on a route to a destination acquired from the server device S, and the calculated position of the object i (i is a positive integral number equal to or larger than 2) thereby to calculate the size of navigational symbol information. Further, the information terminal device 10 has the function of superimposing navigational information including navigational symbol information on an image of a real scene thereby to continuously display them in the real space.

More specifically, the information terminal device 10 of the navigational information display system as shown in FIG. 4 includes a communication-with-server processing unit 2 which acquires information of a previously defined route R(j) to a destination (j is a positive integral number equal to or larger than 2) from the server device S and processes the information thus acquired; an object position calculation unit 1 which obtains latitude and longitude information of electronic tags ET and objects containing images of areas surrounding the electronic tags and then calculates relative distances of the electronic tags and the information concerning the position of an object i; an image-and-object matching processing unit 4 which estimates the relative position of the object i on an image of real scene; and an image-and-route matching processing unit 3 which estimates the display position of the route R(j) to the destination on an image of a real scene (display coordinate R′(j)) to calculate the size of navigational symbol information.

Now, the communication-with-server processing unit 2 has a communication processing unit 20 which obtains information of the route R(j) to the destination previously defined from the server device through the wireless network LN S to convert it to coordinate values of the route R(j); and a communication buffer 21 which temporarily stores the coordinate values of the route R(j) subjected to the conversion by the communication processing unit 20. Typically, the communication processing unit 20 and communication buffer 21 are composed of hardware devices of existing communication equipment.

On the other hand, the object position calculation unit 1 has a latitude-and-longitude information and image receiving unit 11 which receives latitude and longitude information of electronic tags (e.g., at least three electronic tags) ET buried in the real space, and receives an image of a real scene containing unseparated N objects (N is a positive integral number equal to or larger than 2) captured by the information terminal device 10.

The latitude-and-longitude information and image receiving unit 11 has a radio tag recognition unit 13; a latitude-and-longitude information acquisition unit 12; a relative position measurement unit 14; and an image capture unit 15. The radio tag recognition unit 13 recognizes short-range radio signals issued by the electronic tags ET. The latitude-and-longitude information acquisition unit 12 obtains latitude and longitude information representing absolute latitude and longitude coordinates DT(i) of the electronic tags ET from short-range radio signals recognized by the radio tag recognition unit 13. The relative position measurement unit 14 obtains relative distances D(i) of the electronic tags ET with respect to the information terminal device 10. The image capture unit 15 senses an image of a real scene containing the electronic tags ET by means of the camera of the information terminal device 10.

Further, the object position calculation unit 1 has an electronic tag position information selecting unit 16 for appropriately selecting absolute latitude and longitude coordinates DT(i) and relative distances D(i) of the electronic tags ET; and an image buffer 17 for temporarily storing an image of a scene sensed by the image capture unit 15.

More specifically, the image-and-object matching processing unit 4 extracts an image of an area surrounding each electronic tag ET, on the basis of the absolute latitude and longitude coordinates DT(i) and relative distance D(i) of the electronic tags ET selected by the electronic tag position information selecting unit 16, separates an image of an object containing an image of the surrounding area concerned from an image of a real scene (by a pattern recognition technique), and estimates the relative position of the object i on an image of the separated object (i.e., an image of a real scene).

In addition, on the basis of the absolute latitude and longitude coordinates DT(i) of the electronic tags ET appropriately selected by the electronic tag position information selecting unit 16, the information on the route R(j) to the destination, already set in advance and supplied from the communication processing unit 2, and a relative position of the object i estimated by the image-and-object matching processing unit, the image-and-route matching processing unit 3 estimates the display position (display coordinate R′(j)) of the route R(j) to the destination on an image of a real scene to calculate the size of the navigational symbol information.

Further, the information terminal device 10 includes a display control unit 5 which superimposes navigational information containing navigational symbol information, which is calculated by the image-and-route matching processing unit 3, on an image of a real scene stored in the image buffer 17; and a display unit 6 such as a liquid crystal display for displaying a virtual image with the navigational information superimposed thereon in the real space.

It is preferable that the navigational information display system as shown in FIG. 4 is arranged so that as navigational information displayed on the display unit 6 are not only navigational symbol information, but also a time required to get to a destination, information on architectural structures in an area surrounding the destination and gourmet map information of an area surrounding the destination. Otherwise, the display system may be arranged so that marker information showing the location of the destination is displayed.

Further, it is preferable that the function of the entire (or a part) object position calculation unit 1, and the functions of the image-and-object matching processing unit 4 and image-and-route matching processing unit 3 are implemented by operating various programs (software) read out by a CPU (Central Processing Unit) of a computer system, which is not shown. The function of the display control unit 5 can be implemented by operating a program read out by a CPU of a computer system.

Further, an input unit 18 for entering various kinds of information involved in the display of navigational information, and a storage unit 19 including a ROM (Read Only Memory) and a RAM (Random Access Memory) are disposed in the object position calculation unit 1, the image-and-object matching processing unit 4 and the image-and-route matching processing unit 3. Incidentally, ROM and RAM incorporated in CPU may be used instead of the storage unit 19.

More specifically, when a program for displaying navigational information, which is stored in ROM or the like and various kinds of data necessary for operating the program, which are stored in RAM or the like, are read out by a CPU, and when the program read out by the CPU is operated for displaying navigational information, the functions corresponding to those of the object position calculation unit 1, the image-and-object matching processing unit 4, and the image-and-route matching processing unit 3 can be implemented by the program.

It is preferable that the program stored in the ROM or the like in the storage unit 19 includes receiving latitude and longitude information of electronic tags buried in the real space and an image of a real scene containing objects; extracting object images of areas surrounding the electronic tags, followed by separating an object image containing an object image of interest from the image of the real scene calculating a relative distance of each electronic tag, and calculating a position of the object on the separated object image; estimating a display position of the route to the destination on the image of the real scene to calculate a size of navigational symbol information at the indication on the basis of the received latitude and longitude information of the electronic tags, previously set information of a route to a destination, and calculated object position; and superimposing navigational information containing the navigation symbol information on the image of the real scene to display the image of the real scene with the navigational information superimposed thereon as an image of the real space.

Further, with regard to the navigational information display system as shown in FIG. 4, it is preferable to prepare a storage medium 80 of an external storage device 8 such as a disk device, which holds the contents of the program as described above when a computer-readable storage medium (or recording medium) is used to operate CPU. The storage medium is not limited to the form as described above, and it can be provided in forms of various storage media, portable media including a floppy disk, MO (Magneto-Optical Disk), CD-R(Compact Disk-Recordable), and CD-ROM (Compact Disk Read-only Memory), and other storage media.

With regard to the embodiment shown in FIG. 4, it is preferable that a person at a remote location traces a route to a destination on an electronic map or an electronic paper, such as an Anoto paper or ultrasonic paper in real time, whereby it is possible to convey navigational information concerning the route to the destination to a person in the real space correctly and rapidly.

Further, it is preferable that when a user picks up the latitude and longitude information of electronic tags installed in various places over a town, and sets up a virtual balloon in the real space or virtually displays a route to a destination in order to indicate the user's position to another person in the same area, but out of sight of the user. Therefore, it is possible for the user to notify another person in the same area, who is out of sight of the user, as to where the user is.

Further, it is preferable that when preparing for getting to a unknown location, a user traces a route to the destination on an electronic map thereby to make the information terminal device electronically memorize the route, and then the user obtains latitude and longitude information of electronic tags installed in an area surrounding the location, which allows the user to easily carry out navigation in a location absolutely unfamiliar to the user.

According to the embodiment shown by FIG. 4, when latitude and longitude information acquired from electronic tags installed in the real space, and objects containing images of areas surrounding the electronic tags are used to estimate a position of previously set navigational information (e.g., information on a route to a destination) in the real space, the navigational information can be superimposed onto an image of a real scene captured by a camera or the like, and displayed continuously. Therefore, it is possible to carry out navigation efficiently even when GPS cannot be used.

Further, according to the embodiment shown by FIG. 4, an information terminal device carried by a user obtains navigational information without installing navigational information in an electronic tag or putting navigational information in a link destination specified by an electronic tag. Therefore, customized navigational information can be sent to a user. In addition, it is possible for a plurality of navigational information providers to utilize a navigational information display system.

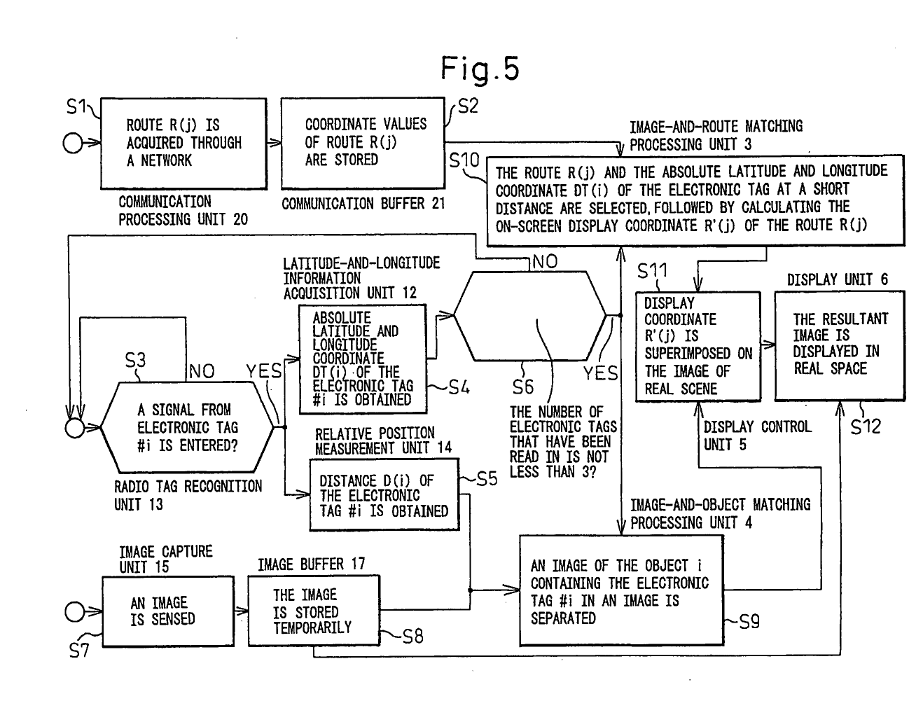

FIG. 5 is a flowchart explaining a process flow to display navigational information according to the present invention. Here, a method which operates the CPU in the information terminal device 10 to execute the process flow in order to display navigational information according to the present invention will be described.

In the navigational information display system, etc., described with reference to FIG. 4, the information about a route (j) to a destination previously set by the external information device 7 is sent out from the server device S to the communication processing unit 2 in the information terminal device 10 through the wireless network LN. First, as shown in Step S1, in the communication processing unit 20, the previously set information on the route R(j) to the destination is obtained and converted into corresponding coordinate values of the route R(j).

Subsequently, as shown in Step S2 coordinate values of the route R(j) are temporarily stored in the communication buffer 21.

Then, as shown in Step S3 the radio tag recognition unit 13 determines whether or not a short-range radio signal from one electronic tag ET(#i) of electronic tags installed in the real space has been entered. When a short-range radio signal from one electronic tag ET(#i) is entered into the radio tag recognition unit 13, the latitude-and-longitude information acquisition unit 12 obtains absolute latitude and longitude coordinate DT(i) of the electronic tag ET(#i) contained in a short-range radio signal from the electronic tag ET(#i) as shown in Step S4.

Further, as shown in Step S5, the relative position measurement unit 14 obtains a relative distance D(i) of one electronic tag ET(#i) with respect to the information terminal device 10.

Still further, as shown in Step S6, whether or not the number of electronic tags ET to be read by the latitude-and-longitude information acquisition unit 12 is not less than two is checked. In general, to determine the display position of the route R(j) until the destination on an actual three-dimensional image, it is necessary to obtain the corresponding absolute latitude and longitude coordinates DT(i) from at least three electronic tags ET(#i) respectively.

Then, as shown in Step S7, the image capture unit 15 senses an image of a real scene containing electronic tags (e.g., three or more electronic tags ET(#i)). Thereafter, as shown in Step S8, an image of a real scene sensed by the image capture unit 15 is temporarily stored in the image buffer 17.

Further, as shown in Step S9, on the basis of the absolute latitude and longitude coordinate DT(i) of the electronic tag ET(#i) and the relative distance D(i) thereof, the image-and-object matching processing unit 4 extracts an image of an area surrounding the electronic tag ET(#i), separates the image of the object containing the image of the surrounding area from the image of the real scene stored in the image buffer 17, and estimates the relative position of the object i on the image of the real scene.

Still further, as shown in Step S10, the coordinate values of the route R(j) stored in the communication buffer 21 and the absolute latitude and longitude coordinate DT(i) of the electronic tag ET(#i) at a short distance are selected, and then the on-screen display coordinate R′(j) of the route R(j) on the image of the real scene is calculated, on the basis of the relative position of the object i estimated by the image-and-object matching processing unit 4.

Then, as shown in Step S11, the display control unit 5 superimposes navigational information containing the display coordinate R′(j) of the route-R(j) calculated by the image-and-route matching processing unit 3 on the image of the real scene stored in the image buffer 17.

In the end, as shown in at Step S12, the display unit 6 displays, in the image of real space, a virtual image, on which the navigational information containing the display coordinate R′(j) of the route R(j) is superimposed.

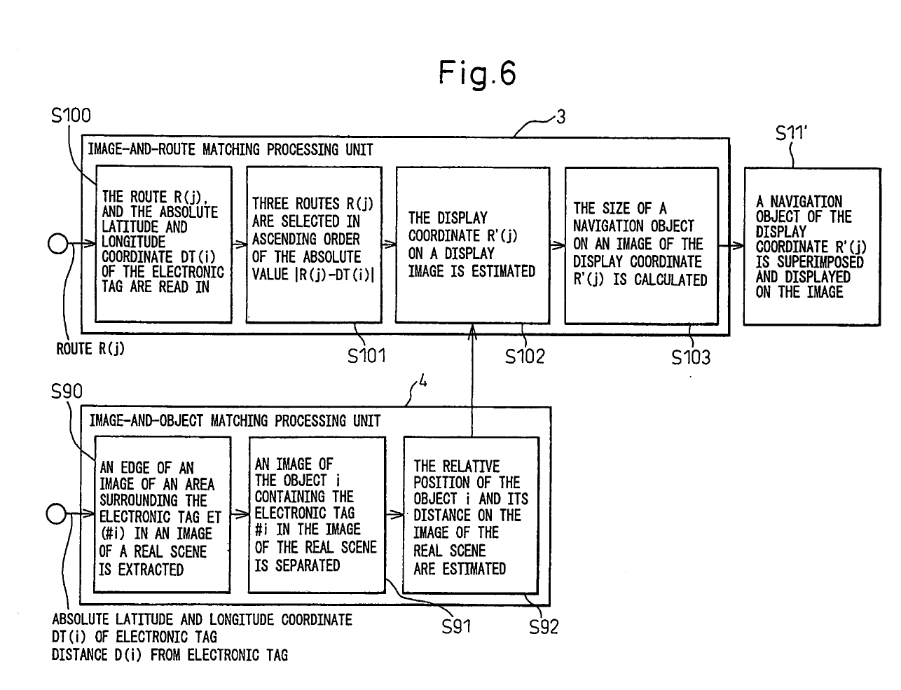

FIG. 6 is a flowchart explaining details of process flows by the image-and-object matching processing unit 4 and the image-and-route matching processing unit 3 as shown in FIG. 5.

In the image-and-object matching processing unit 4, first, as shown in Step S90, an edge of an image of an area surrounding the electronic tag ET(#i) in an image of a real scene is extracted on the basis of the absolute latitude and longitude coordinate DT(i) of the electronic tag ET(#i) and the relative distance D(i) thereof. Next, as shown in Step S91, the image of the object i containing the electronic tag ET(#i) in the image of the real scene is separated from the image of the real scene. Further, as shown in Step S92, the relative position of the object i and its distance (i.e., depth dimension) on the image of the real scene are estimated.

Meanwhile, in the image-and-route matching processing unit 3, first, as shown in Step S100, the coordinate value of the route R(j), and the absolute latitude and longitude coordinate DT(i) of the electronic tag ET(#i) are read in. Subsequently, as shown in Step S101, the coordinate values of three routes R(j) are selected in ascending order of the absolute value |R(j)−DT(i)|.

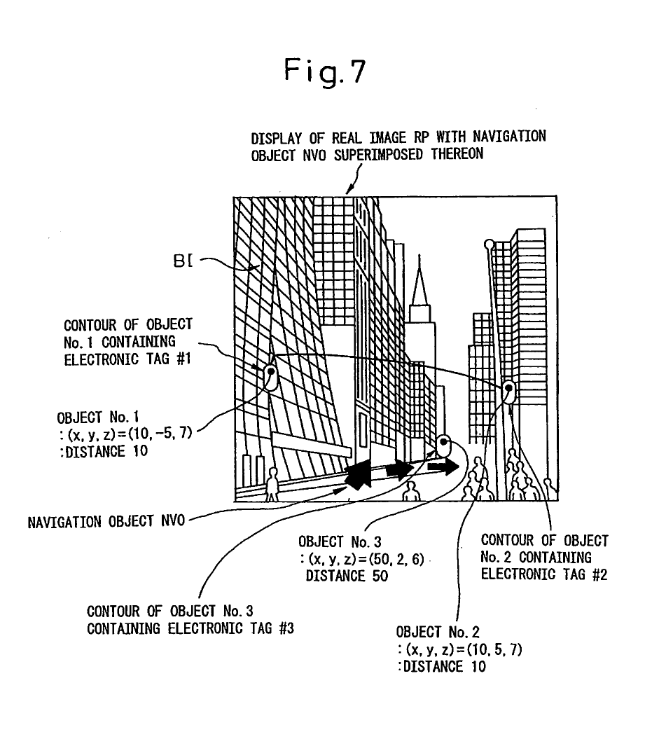

Further, as shown in Step S102, the display coordinate R′(j) of the route R(j) on an image of a real scene to be displayed is estimated on the basis of the relative position and distance of the object i after the separation estimated at Step S92. Then, as shown in Step S103, the size of a navigation object on an image of the display coordinate R′(j) is calculated. Incidentally, “navigation object” means an icon (e.g., the arrowhead icon as shown in FIG. 7, which will be described later) showing navigational symbol information drawn on the image of the real scene.

In the end, as shown in Step S11′, a navigation object of the display coordinate R′(j) calculated at Step S103, which is to be reflected in an image, is superimposed and displayed on the image of the real scene, as in the case of Step S11 described with reference to FIG. 5.

FIG. 7 is a representation of a displayed image showing a condition in which navigational information superimposed on an image of a real scene, which is used according to the present invention, is displayed.

More specifically, in the condition shown by FIG. 7, a navigation object NVO (the arrowhead icon) of the display coordinate R′(j) to be reflected in an image is superimposed on an image of a real scene RP containing architectural structures BI, etc., and displayed on the display unit 6 (see FIG. 5) in the information terminal device 10. In FIG. 7, objects respectively containing three electronic tags ET (#1, #2 and #3) at short distances are displayed with their contours No. 1, No. 2 and No. 3 clearly separated from the image of the real scene RP. For instance, with regard to the object of the contour No. 1, the position (x,y,z)=(10, −5, 7), and the distance representing the depth is 10. With regard to the object of the contour No. 2, the position (x,y,z)=(10, 5, 7), and the distance representing the depth is 10. Further, with regard to the object of the contour No. 3, the position (x,y,z)=(50, 2, 6), and the distance representing the depth is 50.

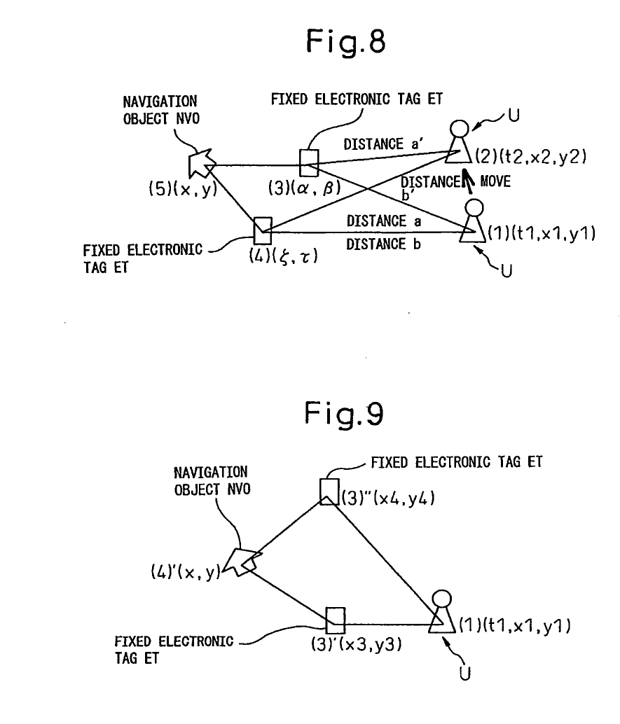

FIG. 8 is a diagrammatic illustration showing the way of using the absolute coordinate of a moving user to estimate the display position of a navigation object. Here, a method which determines the display position of the navigation object NVO by means of the movement of a user U having absolute position information will be described. This can determine the display position of a navigation object even when information on the absolute positions of two fixed electronic tags ET on a planar image of two dimensions is not identified.

More specifically, it is assumed that the user U having absolute position information moves from a position (1) (t1,x1,y1) at the time t1 to a position (2) (t2,x2,y2) at the time t2 when the positions of two electronic tags ET each installed in a road sign, a shop, a store, or the like, in a town are not identified (e.g., when the position (3) (α,β) of the first electronic tag and the position (4) (ζ,τ) of the second electronic tag are not identified). In addition, it is also assumed that the display position (5) (x,y) of a navigation object NVO is not identified.

In this case, when the user U is at the position (1)(t1,x1,y1) at the time t1, the distance a between the fixed first electronic tag and the user U is calculated, and concurrently the distance b between the fixed second electronic tag and the user U is calculated. Further, when the user U moves to the position (2) (t2,x2,y2) at the time t2, the distance a′ between the fixed first electronic tag and the user U and the distance b′ between the fixed second electronic tag and the user U are calculated. Thus, absolute positions (3) (ad) and (4) (ζ,τ) of the fixed two electronic tags are calculated.

As the absolute positions of the two fixed electronic tags are calculated in this way, it is possible to determine the display position (5) (x,y) of the navigation object NVO on a two-dimensional image from the absolute positions of the electronic tags.

Similarly, even when information on the absolute positions of three fixed electronic tags ET on a three-dimensional image is not identified, it is possible to determine the display position of the navigation object NVO on an image of three dimensions by means of the movement (e.g., movement of two times) of the user U having absolute position information.

FIG. 9 is a diagrammatic illustration for showing the way of using fixed tags buried in the real space to estimate the display position of a navigation object. Here, a method to determine the display position of a navigation object NVO when information on two absolute positions of two fixed electronic tags ET on a planar image of two dimensions has been already identified will be described.

More specifically, it is assumed that the user U having absolute position information is at a position (1)(t1,x1,y1) at the time t1 when the positions of two electronic tags ET each installed in a road sign, a shop, a store, or the like, in a town have been identified (e.g., when the position (3)′(x3,y3) of the first electronic tag and the position (3)″(x4,y4) of the second electronic tag have been identified). In addition, it is also assumed that the display position (4)′(x,y) of a navigation object NVO has not been identified.

In this case, when the user U is at the position (1)(t1,x1,y1) at the time t1, the distance between the fixed first electronic tag and the user U is calculated, and concurrently the distance between the fixed second electronic tag and the user U is calculated. As the absolute positions of the two fixed electronic tags have been identified here, it is possible to determine the display position (4)′(x,y) of a navigation object NVO on a two-dimensional image, on the basis of the absolute positions of the two electronic tags and the relative distances between the two electronic tags and the user U.

Similarly, in the case in which information on absolute positions of three fixed electronic tags ET have been identified on a three-dimensional image, it is possible to determine the display position of the navigation object NVO on a three-dimensional image even when the user U having absolute position information does not move.

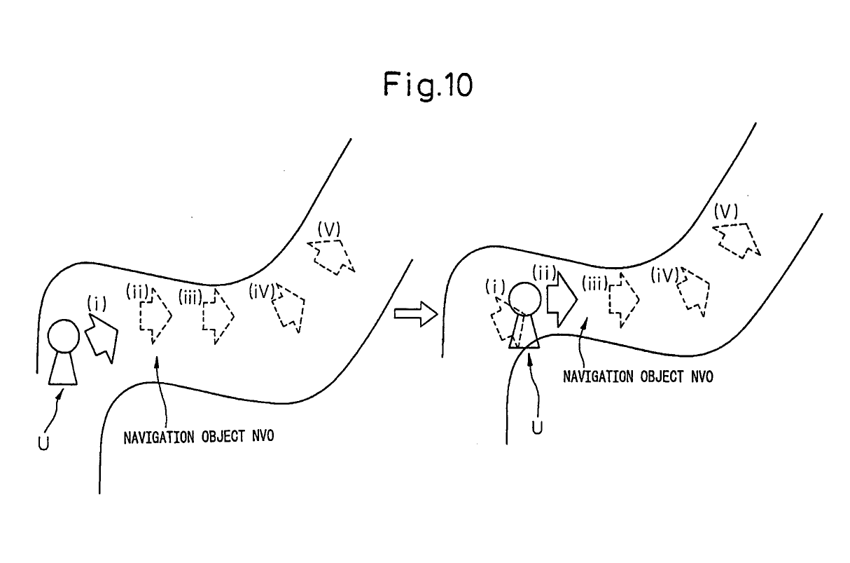

FIG. 10 is a diagrammatic illustration showing the way of using passive type electronic tags to display navigational information. Here, the case of using passive type electronic tags to display navigational information as in the case of the above-mentioned Patent Document 2 will be described.

As shown in FIG. 10, in the case of using a passive type electronic tag, only the information on an electronic tag when the user U approaches the electronic tag (i.e., when the navigation object NVO is brought near to the electronic tag) can be obtained. Therefore, navigational information obtained only when an electronic tag approaches a user can be merely obtained.

More specifically, in the case shown in the left portion of FIG. 10, only the information on the electronic tag (i) which the user U is approaching can be obtained, and information on the electronic tags (ii) to (V) which are farther from the user cannot be obtained.

Further, in the case shown in the right portion of FIG. 10, only the information on the electronic tag (ii), which the user U is approaching when moving, can be obtained, and information on the electronic tags (i) and (iii) to (v) which are further from the user cannot be obtained.

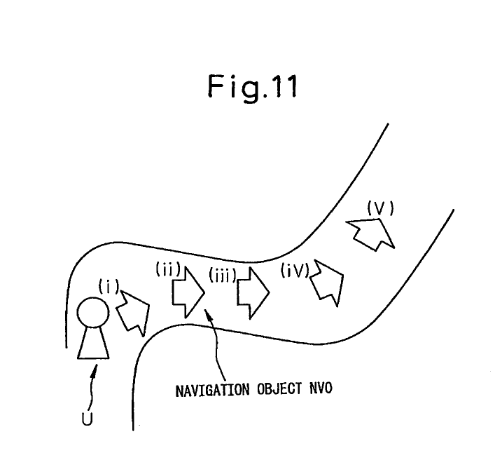

FIG. 11 is a diagrammatic illustration showing the way of using active type electronic tags to display navigational information. Here, the case of using active type electronic tags to display navigational information as in the case of the present invention will be described.

In the case of FIG. 11, as the user U obtains latitude and longitude information from active type electronic tags capable of self-emitting short-range communication radio signals, the range in which radio waves transmitted from the electronic tags can be reached becomes sufficiently longer. Therefore, even when the user U is at the position of the electronic tag (i), (the user can receive information from the electronic tags (ii) to (v) which are farther from the user) and navigation display can be carried out corresponding to the positions of the respective electronic tags.

In this case, as short-range radio signals from electronic tags having sufficiently long range in which radio waves transmitted from the electronic tags can be reached are received, the user U can obtain navigational information on a distant place (within a visible range) even when the user does not move to the place from the position in which the user is at present.

The present invention can be applied to the case in which an information terminal device, such as a portable information terminal, is made to virtually display navigational information including a navigation object in real space by utilizing latitude and longitude information of active type electronic tags, thereby allowing a user to carry out navigation to search for a destination efficiently when getting to a unfamiliar town, a unfamiliar area or the like.

1. A navigational information display system comprising:
a latitude-and-longitude information and image receiving unit for receiving latitude and longitude information of electronic tags which self-emit a short-range radio signal and are installed in real space, and receiving an image of a real scene containing objects captured by an information terminal device;
an image-and-object matching processing unit for extracting an object image of the surroundings of each electronic tag, separating an image of an object containing an object image of interest from the image of the real scene, calculating a relative distance of each electronic tag with respect to the information terminal device, and calculating a position of the object on the separated object image; and
an image-and-route matching processing unit for estimating a display position of a route to a destination set in advance on the image of the real scene to calculate a size of navigational symbol information at the indication on the basis of the received latitude and longitude information of each electronic-tag, information on the route to the destination, and the calculated position of the object;
wherein navigational information containing the navigational symbol information is superimposed on the image of the real scene and displayed in real space.

2. A navigational information display system according to claim 1, wherein not only the navigational symbol information, but also the time required to get to the destination and information on architectural structures in the surroundings of the destination are displayed in real space as the navigational information.

3. A navigational information display system according to claim 1, wherein not only the navigational symbol information, but also marker information showing the location of the destination is displayed in real space as the navigational information.

4. A navigational information display system comprising:
a latitude-and-longitude information and image receiving unit for receiving latitude and longitude information of at least three electronic tags which self-emit a short-range radio signal and are installed in real space, and receiving an image of a real scene containing objects captured by an information terminal device;
an image-and-object matching processing unit for extracting an object image of the surroundings of each electronic tag, separating images of at least three objects containing an object image of interest from the image of the real scene, calculating a relative distance of each electronic tag with respect to the information terminal device, and calculating positions of the at least three objects on the separated object images; and
an image-and-route matching processing unit for estimating a display position of a route to a destination set in advance on the image of the real scene to calculate a size of navigational symbol information at the indication on the basis of the received latitude and longitude information of each electronic tag, information on the route to the destination, and the calculated object positions;
wherein navigational information containing the navigational symbol information is superimposed on the image of the real scene and displayed in real space.

5. A navigational information display system according to claim 4, wherein not only the navigational symbol information, but also the time required to get to the destination and information on architectural structures in the surroundings of the destination are displayed in real space as the navigational information.

6. A navigational information display system according to claim 4, wherein not only the navigational symbol information, but also marker information showing the location of the destination is displayed in real space as the navigational information.

7. A navigational information display method including:
receiving latitude and longitude information of electronic tags which self-emit a short-range radio signal by themselves and are installed in real space, and an image of a real scene containing objects;
extracting an object image of the surroundings of each electronic tag, followed by separating an image of an object containing an object image of interest from the image of the real scene, calculating a relative distance of each electronic tag, and calculating a position of the object on the separated object image;
estimating a display position of a route to a destination set in advance on the image of the real scene to calculate a size of navigational symbol information at the indication on the basis of the received latitude and longitude information of each electronic tag, information on the route to the destination, and the calculated position of the object; and
superimposing navigational information containing the navigational symbol information on the image of the real scene to display the image of the real scene with the navigational information superimposed thereon in real space.

8. A navigational information display method according to claim 7, wherein not only the navigational symbol information, but also the time required to get to the destination and information on architectural structures in the surroundings of the destination are displayed in real space as the navigational information.

9. A navigational information display method according to claim 7, wherein not only the navigational symbol information, but also marker information showing the location of the destination is displayed in real space as the navigational information.

10. A computer-readable recording medium having stored thereon a program for making a computer to execute the steps of:
receiving latitude and longitude information of electronic tags which self-emit a short-range radio signal by themselves and are installed in real space, and an image of a real scene containing objects;
extracting an object image of the surroundings of each electronic tag, followed by separating an image of an object containing an object image of interest from the image of the real scene, calculating a relative distance of each electronic tag, and calculating a position of the object on the separated object image;
estimating a display position of a route to a destination set in advance on the image of the real scene to calculate a size of navigational symbol information at the indication on the basis of the received latitude and longitude information of each electronic tag, information on the route to the destination, and the calculated position of the object; and
superimposing navigational information containing the navigational symbol information on the image of the real scene to display the image of the real scene with the navigational information superimposed thereon in real space.
